(19) United States
(12) Patent Application Publication
(10) Pub. No.: US 2009/0211406 A1
(43) Pub. Date: Aug. 27, 2009

(54) Ratchet Screwdriver That Stores Tips Of Different Sizes

(76) Inventor: Shin-Chi Ho, Dali City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/034,794

(22) Filed: Feb. 21, 2008

(51) Int. Cl. B25B 15/04

(52) U.S. Cl. 81/60

(57) ABSTRACT

A ratchet screwdriver includes a handle having an inside provided with a plurality of receiving chambers, a ratchet device mounted on the handle, a shank having a first end connected with the ratchet device and a second end provided with a drive head, and a cover rotatably mounted on the handle and provided with an exposing hole that is movable to align with one of the receiving chambers. Thus, the receiving chambers of the handle receive and store a plurality of tips of different sizes and specifications, thereby facilitating a user carrying the tips. In addition, the exposing hole of the cover is movable to align with any one of the receiving chambers of the handle to facilitate the user identifying the tip.

### BACKGROUND OF THE INVENTION

1. Field of the Invention

The present invention relates to a screwdriver and, more particularly, to a ratchet screwdriver to drive a workpiece, such as a screw, nut and the like.

2. Description of the Related Art

A conventional ratchet screwdriver comprises a handle, a ratchet device mounted on the handle, and a shank having a first end connected with the ratchet device and a second end provided with a drive head. In operation, the drive head of the shank co-operates tips of different sizes and specifications so as to drive a workpiece, such as a screw, nut and the like. However, the user has to provide a tool box to receive the tips of different sizes and specifications, thereby causing a burden to the user. In addition, the ratchet screwdriver is inoperative when the tips are missed, thereby causing inconvenience to the user when operating the ratchet screwdriver. Further, the tips contact each other in the tool box, so that the tips are easily worn out due to frequent collisions.

### BRIEF SUMMARY OF THE INVENTION

In accordance with the present invention, there is provided a ratchet screwdriver, comprising a handle having an inside provided with a plurality of receiving chambers, a ratchet device mounted on the handle, a shank having a first end connected with the ratchet device and a second end provided with a drive head, and a cover rotatably mounted on the handle to cover the receiving chambers of the handle and provided with an exposing hole that is movable to align with one of the receiving chambers of the handle.

The primary objective of the present invention is to provide a ratchet screwdriver that stores tips of different sizes.

Another objective of the present invention is to provide a ratchet screwdriver, wherein the receiving chambers of the handle are used to receive and store a plurality of tips of different sizes and specifications, thereby facilitating a user carrying the tips.

A further objective of the present invention is to provide a ratchet screwdriver, wherein the receiving chambers of the handle separate from each other to store the tips individually so that the tips will not contact each other, thereby preventing the tips from being worn out due to frequent collisions.

A further objective of the present invention is to provide a ratchet screwdriver, wherein the exposing hole of the cover is movable to align with any one of the receiving chambers of the handle to facilitate the user identifying the tip, so that the ratchet screwdriver can provide an identification function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a ratchet screwdriver in accordance with the preferred embodiment of the present invention.

FIG. 2 is an exploded perspective view of the ratchet screwdriver as shown in FIG. 1.

FIG. 3 is a bottom perspective view of a limit member of the ratchet screwdriver as shown in FIG. 2.

FIG. 4 is a front cross-sectional view of the ratchet screwdriver as shown in FIG. 1.

FIG. 5 is a schematic operational view of the ratchet screwdriver as shown in FIG. 4 in use.

### DETAILED DESCRIPTION OF THE INVENTION

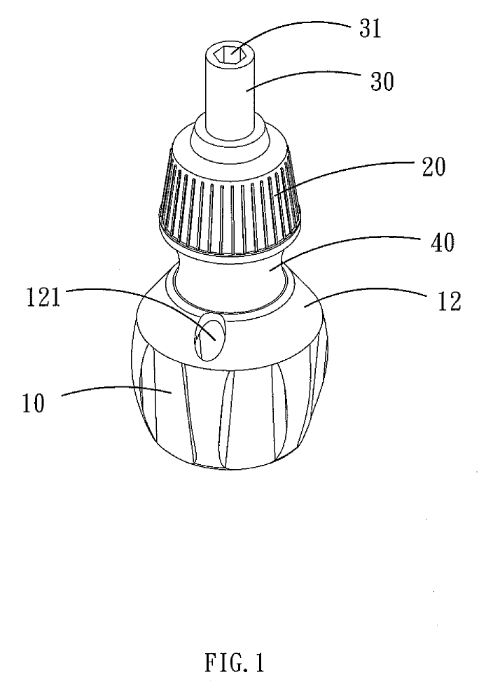

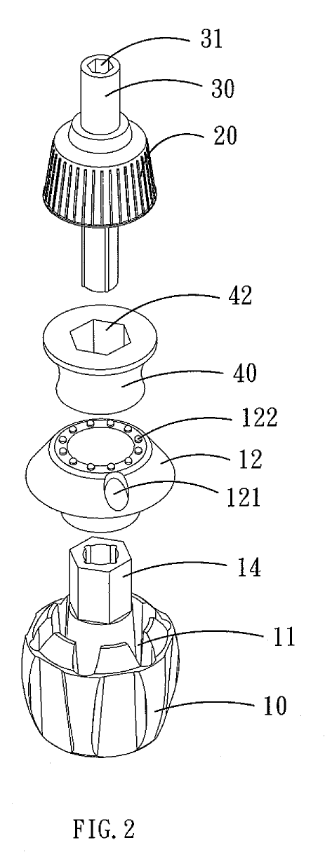

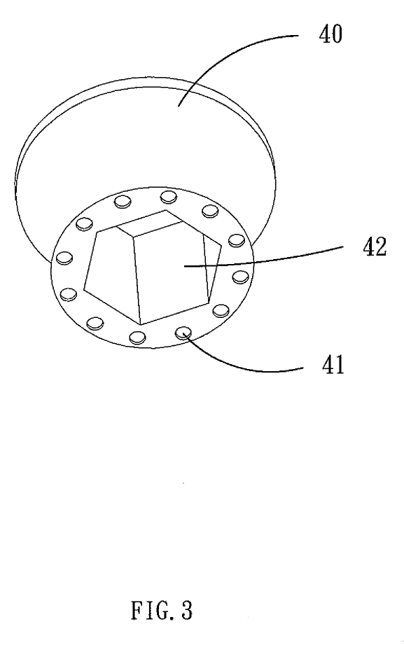

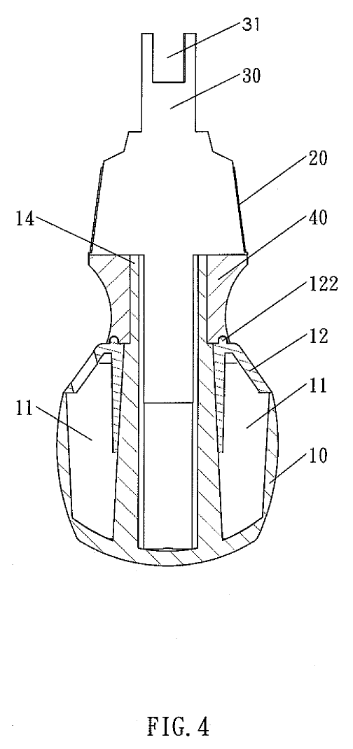

Referring to the drawings and initially to FIGS. 1-4, a ratchet screwdriver in accordance with the preferred embodiment of the present invention comprises a handle 10 having an inside provided with a plurality of receiving chambers 11, a ratchet device 20 mounted on the handle 10, a shank 30 having a first end connected with the ratchet device 20 and a second end provided with a drive head 31, a cover 12 rotatably mounted on the handle 10 to cover the receiving chambers 11 of the handle 10 and provided with an exposing hole 121 that is movable to align with one of the receiving chambers 11 of the handle 10, and a limit member 40 abutting the cover 12 to limit movement of the cover 12.

The handle 10 has an end portion provided with a protruding mounting stud 14. The mounting stud 14 of the handle 10 has a substantially hexagonal shape and is located at a central portion of the receiving chambers 11. The receiving chambers 11 of the handle 10 separate from each other and surrounds the mounting stud 14. Each of the receiving chambers 11 of the handle 10 extends in a longitudinal direction of the handle 10 and is inclined relative to the longitudinal direction of the handle 10. Each of the receiving chambers 11 of the handle 10 is fully covered and sealed by a periphery of the cover 12 so that only one of the receiving chambers 11 of the handle 10 is exposed outwardly from the exposing hole 121 of the cover 12.

The cover 12 is rotatably mounted on the mounting stud 14 of the handle 10 and is located between the handle 10 and the limit member 40. The cover 12 is rotatable between the handle 10 and the limit member 40 and has a side provided with a plurality of positioning bosses 122 which are arranged in an annular shape.

The limit member 40 is mounted on the mounting stud 14 of the handle 10 and is located between the cover 12 and the ratchet device 20. The limit member 40 has an inside provided with a through hole 42 mounted on the mounting stud 14 of the handle 10. The through hole 42 of the limit member 40 has a substantially hexagonal shape to correspond to that of the mounting stud 14 of the handle 10 so that the limit member 40 is non-rotatable relative to the handle 10 and the cover 12. The limit member 40 has a side provided with a plurality of positioning holes 41 which are arranged in an annular shape to position the positioning bosses 122 of the cover 12 temporarily.

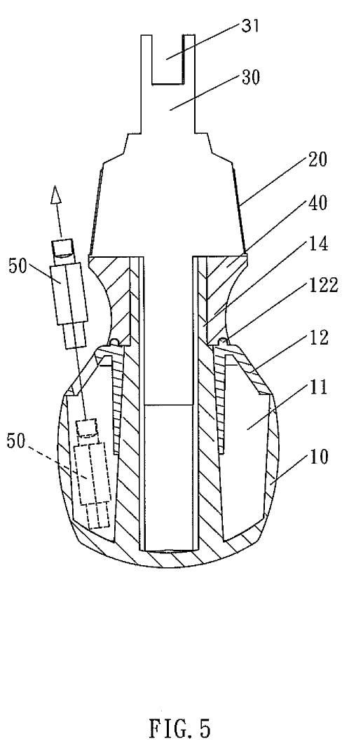

In practice, referring to FIGS. 1-5, the receiving chambers 11 of the handle 10 are used to receive and store a plurality of tips 50 which are used to co-operate with the drive head 31 of the shank 30. When the exposing hole 121 of the cover 12 is movable to align with one of the receiving chambers 11 of the handle 10, the tip 50 contained in the respective one of the receiving chambers 11 of the handle 10 can be taken from the exposing hole 121 of the cover 12 as shown in FIG. 5 for use with a user. At this time, the positioning holes 41 of the limit member 40 can position the positioning bosses 122 of the cover 12 so as to position the cover 12 temporarily so that the cover 12 is rotatable step by step.

Accordingly, the receiving chambers 11 of the handle 10 are used to receive and store a plurality of tips 50 of different sizes and specifications, thereby facilitating a user carrying the tips 50. In addition, the receiving chambers 11 of the handle 10 separate from each other to store the tips 50 individually so that the tips 50 will not contact each other, thereby preventing the tips 50 from being worn out due to frequent collisions. Further, the exposing hole 121 of the cover 12 is movable to align with any one of the receiving chambers 11 of the handle 10 to facilitate the user identifying the tip 50, so that the ratchet screwdriver can provide an identification function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A ratchet screwdriver, comprising:
a handle having an inside provided with a plurality of receiving chambers;
a ratchet device mounted on the handle;
a shank having a first end connected with the ratchet device and a second end provided with a drive head;
a cover rotatably mounted on the handle to cover the receiving chambers of the handle and provided with an exposing hole that is movable to align with one of the receiving chambers of the handle;
wherein each of the receiving chambers of the handle extends in a longitudinal direction of the handle;
each of the receiving chambers of the handle is inclined relative to the longitudinal direction of the handle.

2. The ratchet screwdriver in accordance with claim 1, further comprising:
a limit member abutting the cover to limit movement of the cover.

3. The ratchet screwdriver in accordance with claim 1, wherein the receiving chambers of the handle separate from each other.

4. (canceled)

5. (canceled)

6. The ratchet screwdriver in accordance with claim 2, wherein
the cover has a side provided with a plurality of positioning bosses;
the limit member has a side provided with a plurality of positioning holes to position the positioning bosses of the cover temporarily.

7. The ratchet screwdriver in accordance with claim 6, wherein
the positioning bosses of the cover are arranged in an annular shape;
the positioning holes of the limit member are arranged in an annular shape.

8. A ratchet screwdriver, comprising:
a handle having an inside provided with a plurality of receiving chambers;
a ratchet device mounted on the handle;
a shank having a first end connected with the ratchet device and a second end provided with a drive head;
a cover rotatably mounted on the handle to cover the receiving chambers of the handle and provided with an exposing hole that is movable to align with one of the receiving chambers of the handle;
wherein each of the receiving chambers of the handle is fully covered and sealed by a periphery of the cover so that only one of the receiving chambers of the handle is exposed outwardly from the exposing hole of the cover.

9. The ratchet screwdriver in accordance with claim 2, wherein the cover is rotatable between the handle and the limit member.

10. A ratchet screwdriver, comprising:
a handle having an inside provided with a plurality of receiving chambers;
a ratchet device mounted on the handle;
a shank having a first end connected with the ratchet device and a second end provided with a drive head;
a cover rotatably mounted on the handle to cover the receiving chambers of the handle and provided with an exposing hole that is movable to align with one of the receiving chambers of the handle;
a limit member abutting the cover to limit movement of the cover;
wherein the handle has an end portion provided with a protruding mounting stud;
the mounting stud of the handle is located at a central portion of the receiving chambers.

11. (canceled)

12. The ratchet screwdriver in accordance with claim 10, wherein the receiving chambers of the handle surrounds the mounting stud.

13. The ratchet screwdriver in accordance with claim 10, wherein the cover is rotatably mounted on the mounting stud of the handle and is located between the handle and the limit member.

14. The ratchet screwdriver in accordance with claim 10, wherein the limit member is mounted on the mounting stud of the handle and is located between the cover and the ratchet device.

15. The ratchet screwdriver in accordance with claim 10, wherein the limit member has an inside provided with a through hole mounted on the mounting stud of the handle.

16. The ratchet screwdriver in accordance with claim 15, wherein
the mounting stud of the handle has a substantially hexagonal shape;
the through hole of the limit member has a substantially hexagonal shape to correspond to that of the mounting stud of the handle so that the limit member is non-rotatable relative to the handle and the cover.
